(19) United States
(12) Patent Application Publication
(10) Pub. No.: US 2009/0316870 A1
(43) Pub. Date: Dec. 24, 2009

(54) Devices and Methods for Performing N-Way Mute for N-Way Voice Over Internet Protocol (VOIP) Calls

(75) Inventors: Jeffrey Wise, Buffalo Grove, IL (US); William Alberth, JR., Prairie Grove, IL (US); Scott Droste, Crystal Lake, IL (US); Scott Steele, Seoul (KR)

Correspondence Address: Motorola, Inc., 600 North US Highway 45, Libertyville, IL, 60048, US

(73) Assignee: MOTOROLA, INC., Libertyville, IL (US)

(21) Appl. No.: 12/142,012

(22) Filed: Jun. 19, 2008

(51) Int. Cl. H04M 3/42

(52) U.S. Cl. 379/202.01

(57) ABSTRACT

The disclosed are methods and computing devices configured to engage in Voice Over Internet Protocol (VOIP) conference calls and configured to participate as a moderator of VOIP conference calls allow a moderator or delegate to monitor the mute status of call participants and/or control which participants are muted. In this way, a participant would not be required to necessarily adhere to conference call muting etiquette. For example, in the event that a participant's line is noisy, which may be unknown to the participant, the moderator could mute the line. Other distractions to the conference call as a whole could therefore be controlled as well. The ability to mute determine and/or control the muting of a participant device furthermore enables the moderator to engage rules of conduct and/or adhere to rules of order that may be desirable in particular types of conference calls.

### FIELD

Disclosed are methods and computing devices configured to engage in Voice Over Internet Protocol (VOIP) conference calls, and in particular disclosed are methods and devices configured to participate as a moderator of VOIP N-way conference calls and monitor the mute status of call participants and/or control which participants are muted.

### BACKGROUND

Conference calls are used by business persons daily to meet with remote parties, both internally and outside of their company. Beneficially, travel costs can be cut by conference calls. Moreover, workers may be more productive by not having to attend out-of-office meetings. In the financial marketplace, a conference call is an event in which investors can call into a special telephone number to hear a company management report. While the average investor is muted on the call, analysts may converse with the reporting company. Conference calls are increasingly used in conjunction with web conferences where presentations or documents are shared via the Internet.

Conference calls can also be used for entertainment or social purposes. Conference calls are also beginning to cross over into the world of podcasting and social networking, which in turn fosters new kinds of interaction patterns. Live streaming or broadcasting of conference calls allows large audiences to access a call without a conference bridge.

Large telecommunications providers and other large to medium conferencing service providers maintain a dominate position in the conferencing niche. However, the Internet and improved global (Voice over Internet Protocol) VOIP networks have helped to significantly reduce the barrier of entry into this niche. VOIP uses a broadband or dial up Internet connection to allow users to make peer-to-peer phone calls using a computer or other computing device such as an Internet-enabled mobile communication device. Typically, a VOIP conference call will employ a moderator.

Conference call etiquette includes that each participant should minimize noise and interruptions. A particular participant should know that all of the other participants can hear noise ambient to the particular participant. Etiquette requires that each participant place the telephone on mute if local conversations take place, if there is background noise, or if they have a noisy line. However, it may not occur to a participant to mute their line since they may not realize that their line is noisy or that the ambient noise at their location is carried into the call. Also, conference call etiquette discourages participants who often interrupt other conference participants or who dominate the conversation topic. Other distractions in a conference call may be an activated call waiting, or placing the call on hold with hold music. Mobile communication devices, when used, may introduce static and other noise. Echoes in international calls are also common distractions.

### BRIEF DESCRIPTION OF THE DRAWINGS

FIG. 1 depicts a plurality of computing devices such as mobile telephones are depicted in a four-way conference call including a moderator;

FIG. 2 depicts an embodiment of a computing device having a display that may indicate if communication between the computing device and one or more of the plurality of participant devices has been muted via a mute command interface of the computing device;

FIG. 3 is an embodiment of a computing device architecture diagram;

FIG. 4 is a flow chart of an embodiment of a method of a computing device that may be configured to engage in Voice Over Internet Protocol (VOIP) conference calls and may be configured to participate as a moderator of VOIP conference calls;

FIG. 5 is another flowchart of an embodiment of a method of a computing device that may be configured to engage in VOIP conference calls and may be configured to participate as a moderator of VOIP conference calls; and

FIG. 6 is a flowchart of an embodiment of a method, and in particular an overview of some options described below of a computing device that may be configured to engage in VOIP conference calls that may be configured to participate as a moderator of VOIP conference calls.

### DETAILED DESCRIPTION

It would be beneficial if a moderator could monitor and/or control which participants are muted in a conference call and which participants are not muted in the conference call. By monitoring the mute status of participants, the moderator can decide to mute a line if necessary, either manually or automatically. It would also be beneficial if moderator could determine which participants in a conference call had muted their own lines. It would be also beneficial for a moderator to utilize the muting capability of the device so that a conference call could adhere to rules of order during particular types of conference calls.

Disclosed are methods and computing devices configured to engage in Voice Over Internet Protocol (VOIP) conference calls and configured to participate as a moderator of VOIP conference calls. In one embodiment, the computing device may be configured to determine the mute status of one or more of the plurality of participant devices. In accordance with a moderator's decision based on one or more criteria, the moderator may mute or unmute conference one or more participant's lines. Alternatively or in addition, muting participant lines may also be automatically activated. In another embodiment the computing device may be configured to delegate moderator authority.

The moderator or moderator's computing device of the VOIP conference call therefore may be able to determine and/or control the muting of a participant device during the conference call. In this way, a participant would not be required to necessarily adhere to conference call muting etiquette. For example, in the event that a participant's line is noisy, which may be unknown to the participant, the moderator could mute the line. Other distractions to the conference call could therefore be controlled as well. The ability to mute determine and/or control the muting of a participant device furthermore enables the moderator to engage rules of conduct that may be desirable in particular types of conference calls.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims.

It is understood that the use of relational terms, if any, such as first and second, up and down, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. In the interest of brevity and minimization of any risk of obscuring the principles and concepts according to the present invention, discussion of such software and ICs, if any, is limited to the essentials with respect to the principles and concepts within the preferred embodiments.

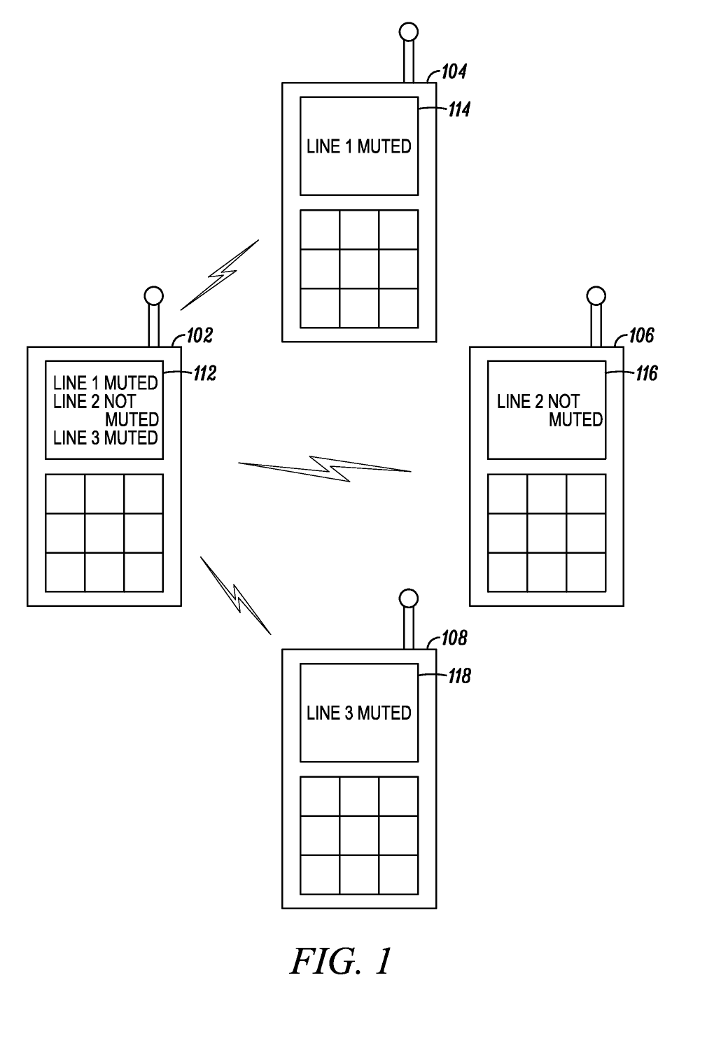

FIG. 1 depicts a plurality of computing devices such as the depicted mobile telephones that are depicted in a four-way conference call having a moderator. The moderator device 102 accordingly may communicate with devices 104, 106 and 108. The devices 104, 106 and 108 may be in communication with one another as well. The leader or moderator of an N-way conference call traditionally is responsible for inviting all participants. However, VOIP also makes it possible to establish a N-way call by having each participant call the moderators VOIP number. Regardless of the manner in which the N-way call is initiated, the moderator 102 may provide the audio mixer on behalf the participants, in this example, devices 104, 106 and 108. Each device in the N-way call may be like-equipped as the moderator, or equipped differently.

The computing device 102 may be any type of computing device, such a mobile communication device, that is VOIP-enabled. One, some, or all of the depicted mobile communication devices of FIG. 1 may be implemented as a cellular telephone (also called a mobile phone). A depicted mobile communication device represents a wide variety of devices that have been developed for use within various networks. Such handheld communication devices include, for example, cellular telephones, messaging devices, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (VoIP).

Mobile communication device 102 depicted as the moderator, for example, includes a display screen 112. Devices 104, 106 and 108 each may include display screens 114, 116 and 118 respectively. Upon or after, in any manner, a VOIP conference call is established between a plurality of participant devices, an interface such as the display screen 112 of the moderator device 102 may be activated or initiated. The interface, in this example, the display screen 112 exhibit indicia that is related to a mute status of one or more of the plurality of participant devices. That is the moderator device 102 may utilize a determining process that may indicate the mute status of the other devices of the N-way call, which is discussed in detail below. Upon determining the mute status of one or more of the plurality of participant devices, via the interface, the mute status of one or more of the plurality of participant devices may be exhibited or otherwise announced, such as by an audio indication. For example, on display 112, it is exhibited that Line 1 is muted, Line 2 is not muted and Line 3 is muted. Line 1, Line 2 and Line 3 are examples of the names of the participant devices. Of course, the participant devices may be indicated by the communication address, such as a telephone number, by the user's name, or company name. Any manner of indicating the participant devices is within the scope of this discussion

On display 114 it is exhibited that Line 1 is muted. On display 116 it is exhibited that Line 2 is not muted. On display 118 it is indicated that Line 3 is muted. Of course each participant device may be similarly equipped as device 102 and the interface also may be of any suitable configuration. For example, the interface may provide audio output. In the example of the display interface, in the event that there are many participants, the exhibited mute status of the participant devices, for example, may be scrolling. Moreover, prompts to a user may be provided to inquire whether exhibition of the mute status of a participant device is desired. It is understand that any type of interface and any manner in which to utilize an interface related to a mute status of one or more of the plurality of participant devices is within the scope of this discussion.

The moderator in this example may be only responsible for the muting determination. Also, other moderating responsibilities may lie with other devices. Moreover, the moderator device 102 may be able to delegate the muting determination to another device, such as devices 104, 106 or 108. In one embodiment, the moderator and delegate duties may be divided. For example, the delegate may monitor the condition of the communication with the participants, and then send a signal to the moderator to mute or unmute a participant's device of the conference. Certain hardware and/or software may be utilized for various moderator capabilities and/or functions as is discussed below.

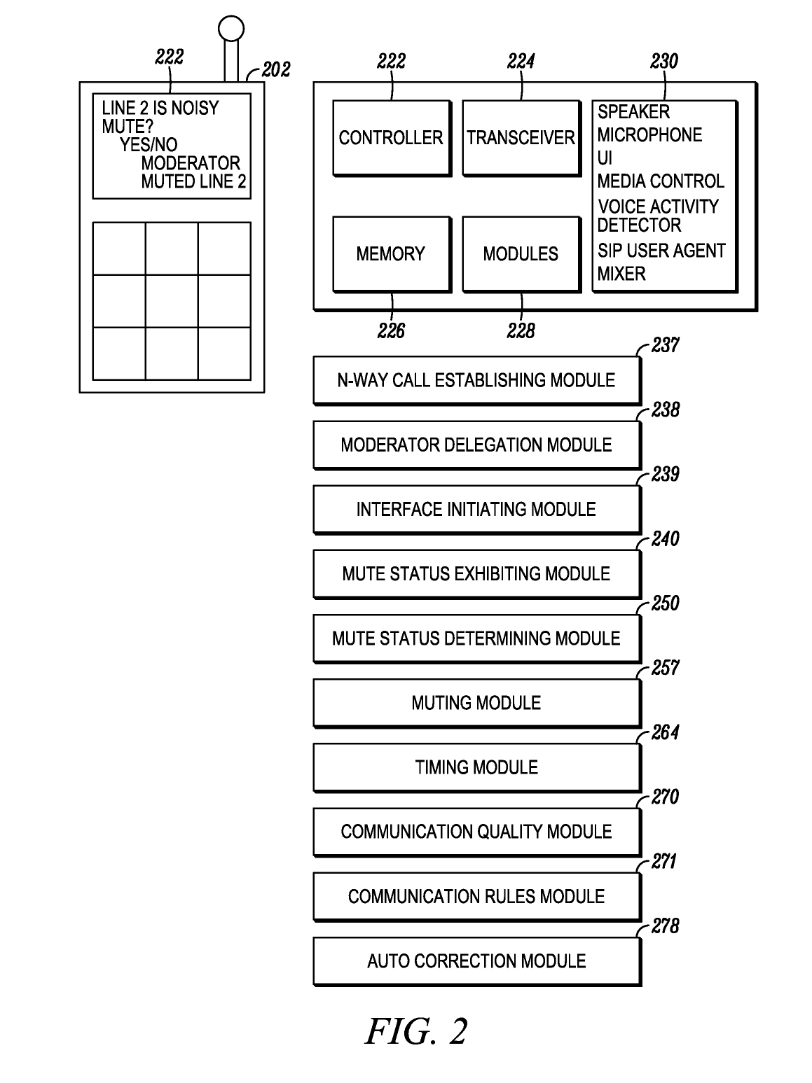

FIG. 2 depicts a computing device 202 having a display 212 that can indicate if communication between the computing device and one or more of the plurality of participant devices was muted via a mute command interface of the computing device. The process to mute a participant may include indicating via the interface, in this example, display 212 that Line 2 is noisy. A prompt may be provided so that the user of the moderator device 202 may chose yes or no. If the user chooses yes, the interface may indicated that the moderator muted Line 2. It is understood that any series of steps to determine whether to mute a line is within the scope of this discussion. Moreover, there may be a combination of manual input and automatic input to determine whether to mute a line. Alternatively, the entire process may be automatic. Additionally, an attempt at auto-correction of a noisy condition or any other condition may be provided as well prior to taking the action of muting a line.

Also depicted are a controller 222, a transceiver 224, a memory 226, and modules 228. The modules can carry out certain processes of the methods as described herein. Steps of methods may involve modules and modules may be inferred by the methods discussed herein. The modules can be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation. The operations in accordance with the modules will be discussed in more detail below. The modules that are depicted include an N-way call establishing module 237, a moderator delegation module 238, an interface initiating module 239, a mute status exhibiting module 240, a mute status determining module 250, a muting module 257, a timing module 264, a communication quality module 270, a communication rules module 271 and an auto-correction module 278.

A computing device 202 that is configured to engage in Voice Over Internet Protocol (VOIP) conference calls and configured to participate as a moderator of VOIP conference calls may include certain hardware and/or software 230 that may be utilized for various moderator capabilities and/or functions. A computing device may have components such as a speaker and microphone, and a user interface such as discussed above. As will be discussed below, media control, a voice activity detector a SIP user agent and a mixer may be utilized to effect moderator capabilities and/or functions.

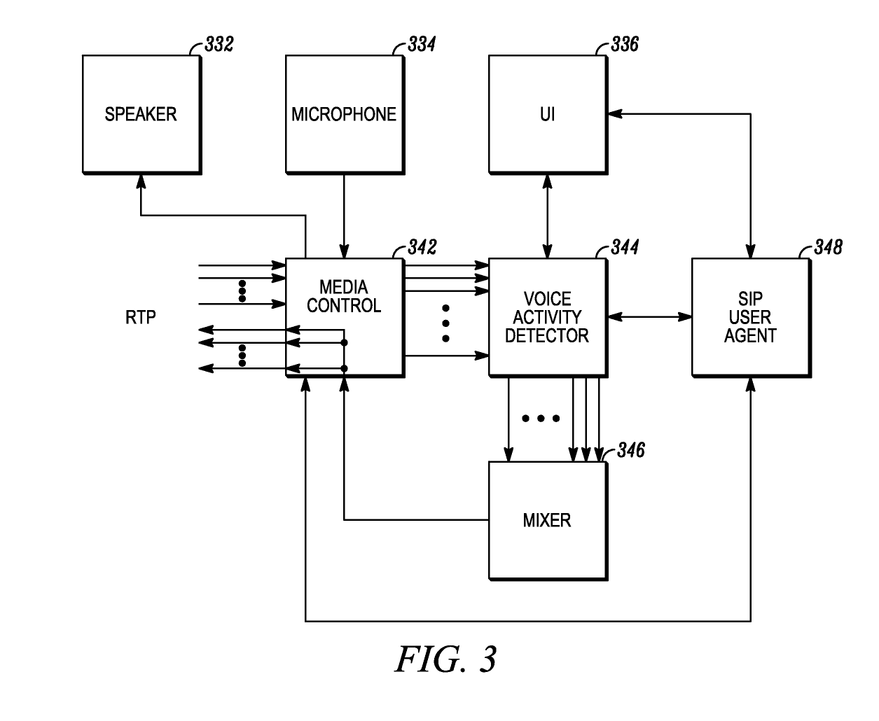

FIG. 3 is a computing device architecture diagram depicting certain hardware and/or software may be utilized for various moderator capabilities and/or functions. As mentioned above, a computing device typically has a speaker 332, microphone 334 and user interface 336. Media control 342 is a voice engine and may be configured to drive a voice activity detector. The media control function would include digital to analog converters (DACs) and analog to digital converters used to interface the speaker and microphone to the digital domain. Vocoders which encode and decode speech signals into compact digital representations may also be included. A voice activity detector (VAD) 344 may detect the presence of speech in an audio signal. An enhanced VAD can include hardware and/an algorithm used in speech processing to detect the presence or absence of human speech. The VAD may be a part of the vocoder in the media control function, and may be combined into the media control function. For each line, for example, of devices 104, 106 and 108 of FIG. 1, the VAD may produce information related to whether the line is sending silence packets, whether the line is sending comfort noise packets, whether the line sent a DTMF sequence to mute or unmute itself, and whether there is voice activity detected on the line. In the case where silence or comfort noise packets are present or if a line is muted via DTMF, the line may be removed from the mixer's 346 input. Also, if the line is unmuted, and there is an absence of human speech the line may be removed from the mixer's 346 input. A list of unmuted lines, those of which are not sending silence or comfort noise or have not sent a DTMF sequence to mute themselves, may be reported to the moderator's user interface 336 such as display 112 (see FIG. 1). Such information may be helpful to determine which lines to manually mute or unmute. A manually muted line or automatically muted line may be removed from the mixer's 346 input.

As mentioned above, a moderator, such as computing device 102 may chose to delegate the ability to manually mute or unmute lines in a N-way call. A delegate computing device, in this example device 104, may include the some of, similar or the same components of the architecture of FIG. 3. A delegate may be a participant in an N-way call or another IP client such as a PC web browser. Using the information determined by the VAD 344, a delegate 104 may instruct the moderator's computing device 102 to mute or unmute one or more lines in an N-way call by sending the moderator device 102 a message to remove or add those lines in accordance with the moderator's mix of mixer 346. It is understood that any particular hardware and/or software may be utilized for various moderator capabilities and/or functions

For deliberative assemblies, the moderator device 102 (see FIG. 1) or designated authority may enforce rules of order, such as Robert's Rules of Order. Before a participant may address the assembly, a participant can request the floor which may be done with token passing. A participant may have a token for a fixed period of time that may be determined by a timer. The allotted time could be ceded to other participants. The moderator device 102 or designated authority may still override the time, and mute the line. Generally, those without a token may be muted. Those muted may use a back channel to request a token from the moderator device 102 or from an unmuted participant. In one embodiment of token passing, a SIP SUBSCRIBE and NOTIFY exchange may be used to request and obtain the floor in accordance with a SIP User Agent 348.

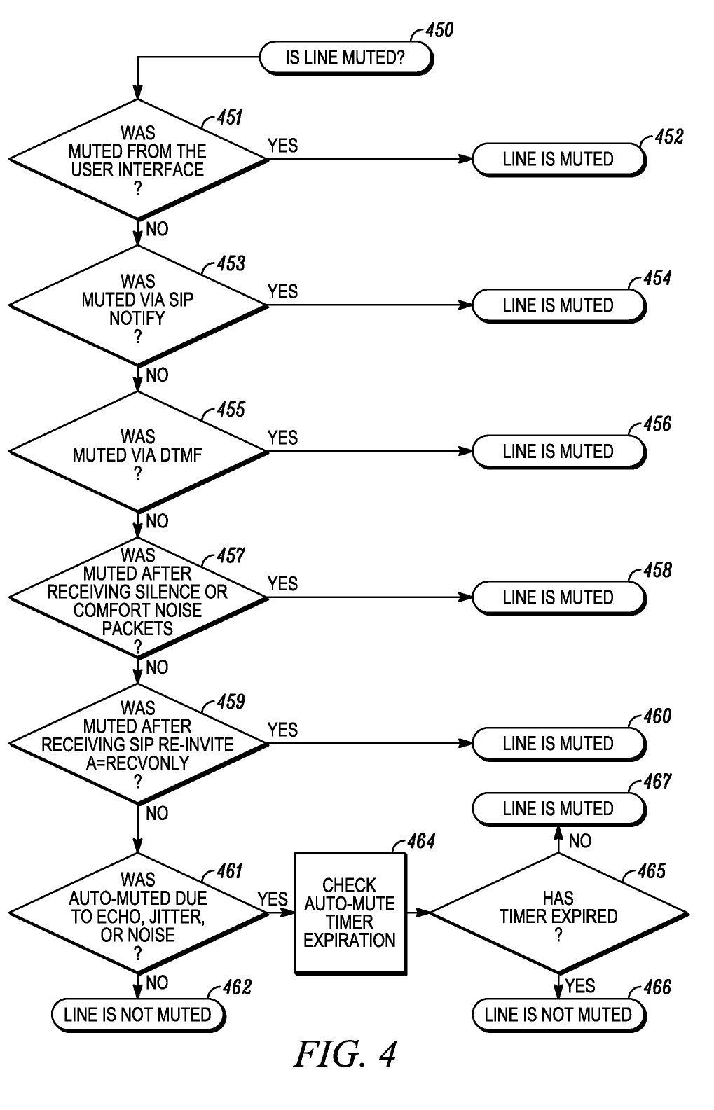

FIG. 4 is a flow chart of an embodiment of a method of a computing device 102 (see FIG. 1) that may be configured to engage in Voice Over Internet Protocol (VOIP) conference calls and may be configured to participate as a moderator of VOIP conference calls. In one embodiment, the moderator device 102 (see FIG. 1) may determine if a participant line has been muted either by the participant or by the moderator device 102 either manually or by an auto-mute process. The steps of the method may include first establishing a VOIP conference call with a plurality of participant devices in accordance with an N-way call establishing module 237 either with the moderator or a delegate in accordance with a moderator delegation module 238. For an indication of the muting status, the method may include initiating an interface related to a mute status of one or more of the plurality of participant devices in accordance with an interface initiating module 239. The steps may also include, as discussed above, indicating via the interface the mute status of one or more of the plurality of participant devices in accordance with mute status exhibiting module 240. Then, as reflected in the flowchart the device 102 may determine 450 the mute status of one or more of the plurality of participant devices, for example devices 104, 106 and/or 108 in accordance with a mute status determining module 250.

A determination can be made and/or indicated by the moderator's device 102 (see FIG. 1) whether 451 a line was muted from the moderator's device 102. For example, display 112 of device 102 may indicate 452 that a line is muted. Moreover, an inquiry 453 may be made whether a line was muted via a SIP Notify to indicate 454 whether the line was muted. Also, an inquiry 455 may be made whether a line was muted via a dual tone multi-frequency (DTMF) signal to indicate 456 whether the line was muted. Additionally, an inquiry 457 may be made whether a line was muted after receiving silence or comfort noise packets to indicate 458 whether the line was muted. On the other hand, an inquiry 459 may be made whether a line was muted after receiving SIP RE-INVITE a=recvonly? to indicate 460 whether the line was muted. This message informs the device that they are invited to participate in a session but their status will be receive only. They can only listen into the conversations, they will not be able to speak or otherwise participate without changing their status.

Furthermore, an inquiry 461 may be made whether a line was manually or auto-muted due to echo, jitter, or noise. If none of the described conditions or other suitable conditions were met, then a line may not be muted 462. In the case of auto-mute, a time may be monitored 464 in accordance with a timing module 264 and a determination 465 may be made as to whether the timer expired may be made. If the time has expired, the line may be unmuted 466. If the timer has not expired, the line may be muted 467 in accordance with muting module 367. Accordingly, there may be many circumstances under which a line may be muted, either by a participant device or by the moderating device. It is understood that the list of examples above is not an exhaustive list. Moreover, it is understood that the steps described above may be determined in any order, and one or more of them may be utilized in such a process.

In any event, with the moderator's ability to mute a line, a participant would not be required to necessarily adhere to conference call muting etiquette. For example, in the event that a participant's line is noisy, which may be unknown to the participant, the moderator could mute the line. Other distractions to the conference call could therefore be controlled as well. The ability to mute determine and/or control the muting of a participant device furthermore enables the moderator to engage rules of conduct that may be desirable in particular types of conference calls.

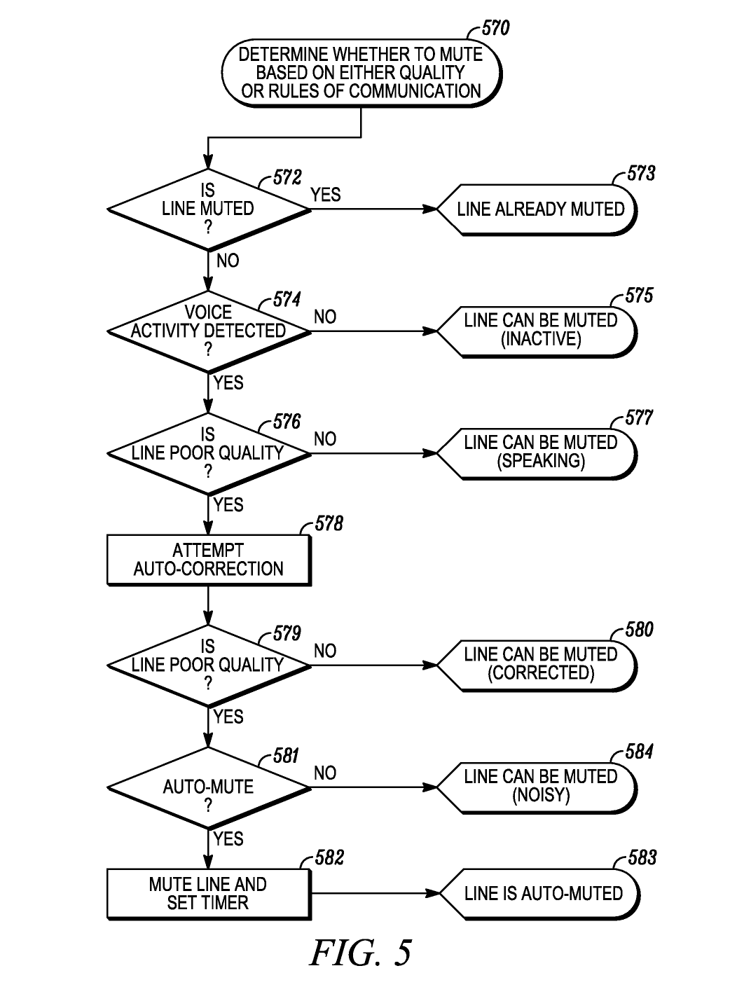

FIG. 5 is a flowchart of a method of a computing device 102 (see FIG. 1) that may be configured to engage in Voice Over Internet Protocol (VOIP) conference calls and may be configured to participate as a moderator of VOIP conference calls. In particular, the process of determining certain conditions under which to mute a line is depicted. That is, the depicted process may include determining 570 whether to mute one or more of the plurality of participant devices based on at least one of a quality characteristic of the communication in accordance with a communication quality determination module 270 or rules of communication between the computing device and the one or more of the plurality of participant devices in accordance with a communication rules module 271.

Initially, an inquiry 572 whether a particular line is already muted may be made. If the line is already muted 573, then the process may end. If the line is not already muted, in accordance with the VAD 344 (see FIG. 3), an inquiry 574 whether voice activity has been detected may be made. If no voice activity is detected, a line may or may not be rendered inactive by muting 575. A line quality inquiry 576 may be made in accordance with communication quality module 570. If the quality of the line is not poor, then the line may or may not be muted 577. In the alternative, an auto-correction may be attempted 578 in accordance with auto-correction module 278. Various method for auto-correction are within the scope of this discussion. After an auto-correction attempt, another line quality inquiry 579 may be made and again, if the line is not poor, the line may or may not be muted 580. If the line quality inquiry 579 is poor, a query 581 as to whether to mute the line may therefore be muted and a timer may be set 582 in accordance with the timer module 264 so that the line is auto-muted 583. There may be a decision at any point in the process, on the other hand, to allow the line to be noisy 584 and unmuted.

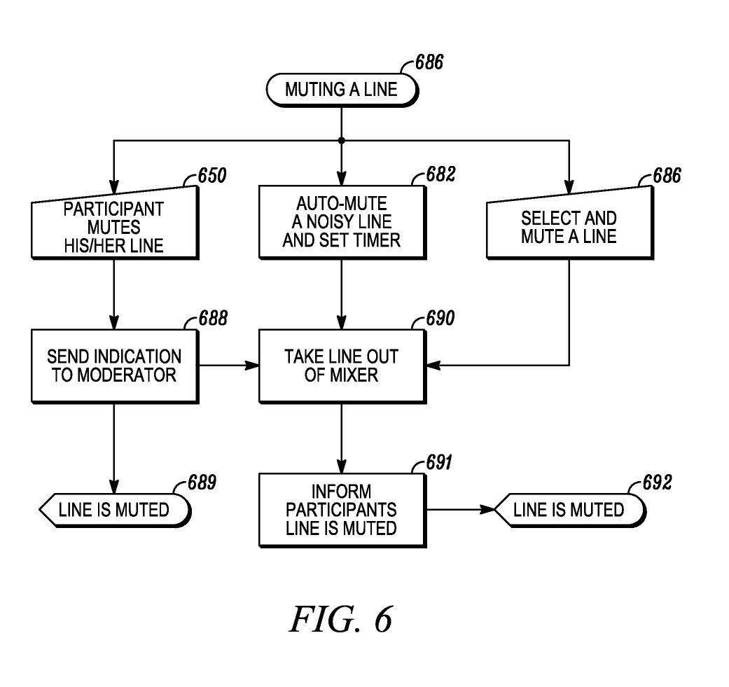

FIG. 6 is a flowchart of a method of a computing device 102 (see FIG. 1) and in particular an overview of some options described above. By muting a line 686, three possibilities are shown. The participant has muted his or her own line 650, or a auto-mute of a noise line has been made and a timer has been set 682, or a line has been selected to be muted 686 for reasons including communication rules, etiquette infractions and/or line disturbances. In the case where the participant mutes his or her own line 650, an indication may be sent 688 to the moderator in any suitable manner to determine 689 that the line is muted and to take the line out 690 of the mixer 346 (see FIG. 3). In the two other examples, where an auto-mute has muted a line, or a line has been selected to mute for any number of reasons, the line is taken out 690 of the mixer 346. There may be an option to inform the particular line and/or other participants 691 that one or more lines are muted 692. As discussed in detail above, the moderator may control the mute status of the line of a conference call by virtue of a software and/or hardware enabled device, for example, including those components illustrated in the architecture diagram of FIG. 3, and in particular the mixer 346. Any other device similarly enabled ay in whole or in part may take on moderator responsibilities.

The disclosed are methods and computing devices configured to engage in Voice Over Internet Protocol (VOIP) conference calls and configured to participate as a moderator of VOIP conference calls allow a moderator or delegate to monitor the mute status of call participants and/or control which participants are muted. In this way, a participant would not be required to necessarily adhere to conference call muting etiquette. For example, in the event that a participant's line is noisy, which may be unknown to the participant, the moderator could mute the line. Other distractions to the conference call as a whole could therefore be controlled as well. The ability to mute determine and/or control the muting of a participant device furthermore enables the moderator to engage rules of conduct and/or adhere to rules of order that may be desirable in particular types of conference calls.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. A method of a computing device configured to engage in Voice Over Internet Protocol (VOIP) conference calls and configured to participate as a moderator of VOIP conference calls, the method comprising:
establishing a VOIP conference call with a plurality of participant devices wherein the computing device is the moderator;
initiating an interface related to a mute status of one or more of the plurality of participant devices;
determining the mute status of one or more of the plurality of participant devices; and
indicating via the interface the mute status of one or more of the plurality of participant devices.

2. The method of claim 1 wherein determining the mute status of one or more of the plurality of participant device further comprises:
indicating if communication between the computing device and one or more of the plurality of participant devices was muted via a mute command interface of the computing device.

3. The method of claim 1 wherein determining the mute status of one or more of the plurality of participant device further comprises:
determining if communication between the computing device and one or more of the plurality of participant devices was muted via Session Initiation Protocol (SIP) Notify.

4. The method of claim 1 wherein determining the mute status of one or more of the plurality of participant device further comprises:
determining if communication between the computing device and one or more of the plurality of participant devices was muted via dual tone multi-frequency signaling (DTMF).

5. The method of claim 1 wherein determining the mute status of one or more of the plurality of participant device further comprises:
determining if communication between the computing device and one or more of the plurality of participant devices was muted in response to receiving at least one of silence or comfort noise packets.

6. The method of claim 1 wherein determining the mute status of one or more of the plurality of participant device further comprises:
determining if communication between the computing device and one or more of the plurality of participant devices was at least one of muted in response to receiving Session Initiation Protocol (SIP) Re-Invite or based on determining at least one of echo, jitter or noise in the communication between the computing device and one or more of the plurality of participant devices.

7. The method of claim 1, wherein a positive mute status has been established, the method, further comprising:
timing the mute status.

8. The method of claim 7, further comprising:
unmuting the communication between the computing device and one or more of the plurality of participant devices upon expiration of the timing of the mute status.

9. The method of claim 1 wherein the computing device is configured to delegate moderator authority, the method further comprising:
delegating at least a portion of moderator authority to another device.

10. A method of a computing device configured to engage in Voice Over Internet Protocol (VOIP) conference calls and configured to participate as a moderator of VOIP conference calls, the method comprising:
establishing a VOIP conference call with a plurality of participant devices, wherein the computing device is the moderator;
initiating an interface related to communication between the computing device and one or more of the plurality of participant devices;
indicating via the interface the status of communication between the computing device and one or more of the plurality of participant devices; and
determining whether to mute one or more of the plurality of participant devices between the computing device in the communication between the computing device and the one or more of the plurality of participant devices based on at least one of a quality characteristic of the communication or rules of communication between the computing device and the one or more of the plurality of participant devices.

11. The method of claim 10, wherein prior to determining whether to mute one or more of the plurality of participant devices based on the quality of the communication between the computing device and the one or more of the plurality of participant devices, the method comprises:
attempting auto-correction of the quality of the communication.

12. The method of claim 10, wherein determining whether to mute one or more of the plurality of participant devices based on the quality of the communication between the computing device and the one or more of the plurality of participant devices, the method comprises:
automatically determining whether to mute one or more of the plurality of participant devices based on the quality of the communication between the computing device and the one or more of the plurality of participant devices.

13. The method of claim 10, further comprising:
initiating an interface related to a mute status of one or more of the plurality of participant devices;
determining the mute status of one or more of the plurality of participant devices; and
indicating via the interface the mute status of one or more of the plurality of participant devices.

14. The method of claim 10 wherein determining whether to mute one or more of the plurality of participant devices based on the quality of the communication between the computing device and the one or more of the plurality of participant devices, comprises:
determining if the quality of the communication between the computing device and one or more of the plurality of participant devices includes at least one of echo, jitter or noise.

15. The method of claim 10 wherein determining whether to mute one or more of the plurality of participant devices based on the rules of the communication between the computing device and the one or more of the plurality of participant device, comprises:
enforcing rules of order using back channel token passing.

16. A computing device, comprising:
a controller configured to receive and execute instructions such that the computing device is configured to participate as a moderator in a Voice Over Internet Protocol (VOIP) conference call with a plurality of participant devices and is configured to delegate moderator authority;
a transceiver coupled to the controller and configured to receive and transmit communication signals for a VOIP conference call; and
a voice activity detector configured to determine a mute status of one or more of the plurality of participant devices.

17. The computing device of claim 16 wherein the voice activity detector is configured to sense at least one of silence, comfort noise packets, or DTMF sequences for muting or unmuting, a presence of human speech to determine a mute status of at least one of the plurality of participant devices.

18. The computing device of claim 16 further comprising:
an interface related to a quality of communication between the computing device and one or more of a plurality of participant devices.

19. The computing device of claim 16 further comprising:
an interface related to the mute status between the computing device and one or more of a plurality of participant devices.

20. The computing device of claim 16 wherein the voice activity device is configured to automatically mute at least one of the plurality of participant devices during a VOIP conference call or to receive user input to mute at least one of the plurality of participant devices during a VOIP conference call.
